(19) United States
(12) Patent Application Publication
(10) Pub. No.: US 2011/0114564 A1
(43) Pub. Date: May 19, 2011

(54) Preventing Silica And Silicate Scale With Inhibitors In Industrial Water Systems

(75) Inventors: Zahid Amjad, Brecksville, OH (US); Robert W. Zuhl, Hudson, OH (US)

(73) Assignee: LUBRIZOL ADVANCED MATERIALS, INC., Cleveland, OH (US)

(21) Appl. No.: 13/002,997

(22) PCT Filed: Jul. 6, 2009
(86) PCT No.: PCT/US09/49677

§ 371 Date: Jan. 7, 2011

Related U.S. Application Data
(60) Provisional application No. 61/078,538, filed on Jul. 7, 2008.

(51) Int. Cl. C02F 5/12; C08G 73/12; C02F 5/14

(52) U.S. Cl. 210/700; 525/187; 210/701; 210/698

(57) ABSTRACT

A method of inhibiting the deposition of silica and silicate compounds on surfaces in water systems by treating the water with an effective amount of an alkoxylated amines or imidized polymer from alkoxylated amines either alone or in combination with acrylic acid or maleic acid homo- or co-polymers and phosphonates.

### DESCRIPTION OF INVENTION

This invention relates to a method for controlling the silica and silicate precipitation and deposition problems in aqueous systems. More particularly, the invention is directed to the use of low level of poly(alkoxylate)-amine and/or imidized acrylic polymer with poly(alkoxylate)-amine either alone or in combination with home-, copolymers containing different functional groups, and phosphonate.

### BACKGROUND OF THE INVENTION

Environmental and economical pressures continue to grow for water treatment industry to reduce water consumption. Cooling towers are large water consuming operations and thus key targets for water conservation programs. One of the first steps many plants take to cut water use is to increase the cycle of concentration in their cooling towers. This tactic is particularly attractive if the towers have been operating at low (2 to 4) cycles. However, there is usually a reason for restricting cycles, and that reason is usually the scale formation (the deposition of insoluble salts on equipment surfaces). Increasing the cycles of water concentrations will increase the concentration of sparingly soluble or scale forming salts and make the water more likely to form scale. Similar scaling potential also exists in membrane-based processes if system recovery is increased to produce a higher ratio of desalinated water. Chemical treatment programs are generally the best methods available to prevent scale.

The solubility of silica is important to the efficient operation of industrial water systems. In areas such as Arizona, California, New Mexico, Texas, Southern Europe, the Pacific Rim, and Latin America, the water used in industrial processes may contain high silica levels from 30 to 120 ppm (parts per million). For example, 80 ppm silica is typical of Mexico City water. One of the problems, with high silica water is that both amorphous silica (SiO₂) and magnesium silicate (MgSiO₃) have limited solubility. When these inorganic salts deposit on heat exchanger or membrane surface, they can seriously interfere with system performance. Water technologists must take into account the presence of magnesium and calcium ions. A pH adjustment to greater than pH 8.5 might result in massive precipitation of a) magnesium silicate if high levels of magnesium ions are present or b) calcium carbonate or calcium phosphate if high levels of these ions are overlooked. In addition, silica precipitation also can be aggravated by the presence of metal ions such as ferrous and/or ferric ions or aluminum ions and their hydroxides. Corroded steel pipes and heat exchangers are prone to silica fouling. In geothermal energy utilization, fouling of equipment surfaces due to silica scaling remains one of the key problems to be solved. The composition and quantity of silica deposit, and the rate at which it forms, is dependent on several factors including pH, temperature, the ratio of calcium/magnesium, and the concentration of polyvalent ions in water. Silica and/or silicate deposits are particularly difficult to remove once they form. Strong chemical cleaning (based on hydrofluoric acid) or laborious mechanical removal usually is required.

The mechanism of silica precipitation, outlined below, is condensation polymerization of silicic acid to polysilicates. The reaction is catalyzed by hydroxide ion and is therefore quite slow at low pH but rapid above pH 7.

Si(OH)₄+OH⁻→(OH)₃SiO⁻+H₂O

Si(OH)₃⁻+Si(OH)₄→(OH)₃Si—O—Si(OH)₃(dimer)+OH⁻

Dimer→Cyclic→Colloidal→Amorphous Silica (scale)

Various additives have been employed to inhibit silica deposition. For example, several compositions based on acrylic acid co-polymers have been taught in several U.S. patents. For example, U.S. Pat. No. 4,711,725 to Amick, et al., teaches acrylic acid co-polymerized with acrylamido alkyl or aryl sulfonate, and substituted acrylamide as metal silicate dispersants. U.S. Pat. No. 5,510,059 to Amjad teaches the use of acrylic acid co-polymerized with diallyl dimethyl ammonium chloride and acrylamide for inhibition of silica polymerization. U.S. Pat. No. 4,328,106 to Harrar, et al., teaches inhibiting silica scaling and precipitation by injecting low concentrations of cationic nitrogen compounds, such as polymeric amines, polymeric imines, and quaternary ammonium compounds. U.S. Pat. No. 4,584,104 to Dubin teaches inhibiting amorphous silica scale formation by treating industrial waters with boron compounds which dissolve or hydrolyze in the industrial water to give the orthoborate ion. U.S. Pat. No. 5,271,847 to Chen, et al. teaches controlling the deposition of silica by the use of a water soluble graft co-polymer of acrylic acid and polyalkylene glycol ether. U.S. Pat. No. 5,271,862 to Freese teaches inhibiting the deposition of silica and silicate compounds by adding a composition consisting of a hydroxyphosphono-acetic acid and a co-polymer of acrylic acid and allyl hydroxypropyl sulfonate ether. U.S. Pat. No. 5,658,465 to Nicholas, et al, teaches the use of poly(2-ethyloxazoline) as a silica polymerization inhibitor. These polymerization inhibitors have allowed for increases in soluble silica to greater than 300 ppm without scale formation. U.S. Pat. No. 6,153,106 to Kelley, et al, teaches the use of polyamide for inhibiting silica scale formation. U.S. Pat. No. 6,017,994 to Carter, et al. teaches the use of water soluble polymers having pendant derivatized amide functionalities for scale inhibition. U.S. Pat. No. 6,051,142 to Roe discloses the use of ethylene oxide-propylene oxide co-polymers as silica inhibitors, U.S. Pat. No. 5,583,183 issued to Darwin, et al. discloses amidized acrylic polymer useful as rheological modifiers in cement compositions.

Despite the large number of publications in the area of scale inhibitors, none provide an effective method to control the troublesome silica and silicate scale. Limiting the level of silica introduced or allowed to accumulate in the aqueous system is still the primary method of dealing with the problem. Therefore, an objective of this invention is to provide a method that effectively inhibits silica and silicate precipitation and deposition in aqueous systems. The present invention provides a means for solving the problem of silica scale inhibition in aqueous systems by the addition of soluble (oxyethylene-oxypropylene)-amine and/or imidized acrylic polymer from (oxyethylene-oxypropylene)-amine reacted with a polymer having pendant carboxylic acid groups either alone or in combination with other materials such as homo-, co-polymers of sulfonated styrene or 2-acrylamido-2-methylpropane sulfonic acid or non-polymeric compounds having different functional groups (e.g., phosphoric acid, citric acid).

### SUMMARY OF THE INVENTION

The present invention is the result of the discovery that certain soluble poly(alkoxylate)-amine and imidized acrylic polymer from poly(alkoxylate)-amine reacted with a polymer having pendant carboxylic acid groups are effective in inhibiting the formation of silica and silicate salts in water systems. These inhibitors can be used alone or in combination with other water treating agents such as phosphoric acids and their salts, phosphonic acids and their salts, metal chelating agents, corrosion inhibitors, oxygen scavengers, homo- and co-polymers of acrylic acid, homo- and co-polymers of maleic acid or anhydride, or acrylic/maleic based polymers.

The inhibitors of the present invention are employed in an effective amount that varies depending on the makeup of the water that is being treated, but the amount will usually be in the range of about 0.5 to about 500 ppm.

### DETAILED DESCRIPTION OF THE INVENTION

In accordance with the present invention, it has been discovered that certain poly(alkoxylate)-amine and imidized acrylic polymer from poly(alkoxylate)-amine reacted with a polymer having pendant carboxylic acid groups are effective treatment agents for reducing the deposition of silica/silicate in aqueous systems. The method of the present invention comprises adding an effective amount of an poly(alkoxylate)-amine, and/or imidized acrylic acid polymer from poly(alkoxylate)-amine reacted with a polymer having pendant carboxylic acid groups or mixtures thereof to an aqueous system being treated. The term poly(alkoxylate) is used to describe polymers derived from polymerizing alkylene oxides of 2 to 4 carbon atoms, such as ethylene oxide, propylene oxide, and butylene oxide. Applicant has also used a similar term “poly(ethylene-propylene oxide)” to mean polymers of ethylene oxide, propylene oxide, or mixtures thereof.

An effective amount of the additive of the present invention can be added to an aqueous system being treated. As used herein, the term effective amount is that amount necessary to control silica/silicate scale deposition in the system being treated. Generally, the effective range will range from about 0.5 to about 500 ppm, in another embodiment from about 0.5 to about 250 or 350 ppm, and in a third embodiment from about 1 to 100 ppm, on an active basis based upon the total weight of the aqueous system being treated.

As used, herein, the term controlling the silica/silicate deposition includes inhibition of silica polymerization, threshold precipitation inhibition, stabilization, dispersion, solubilization, and size reduction of silica, silicates, and calcium and magnesium silicates. The treatments of the present invention are threshold silicate precipitate inhibitors that also stabilize, disperse, and solubilize silica and silicates, and generally reduce the particle size of any precipitated material.

Aqueous system as used herein, means any type of system containing water including, but not limited to, boiler systems, cooling systems, evaporator systems, desalination, gas scrubber systems, systems utilizing geothermal sources, mining, paper manufacturing systems, and the like.

The poly(alkoxylate)-amines of the present invention are well known to those skilled in the art and are commercially available. The treatment materials of the present invention may be added to the aqueous system being treated by any convenient means. A preferred method of addition is to the makeup water systems. In addition, other conventional water treatment agents such as dispersants, scale inhibitors, complexing agents, metal deactivators and passivators, and corrosion inhibitors can be used in combination with treatment of the present invention.

The poly(alkoxylate)-amines also known as polyoxyalkylene amines (also known as polyetheramines) are commercially available. For the purposes of this application, poly(alkoxylate)-amine will mean polymers from alkylene oxides having from 2 to 4 carbon atoms, such as ethylene oxide, propylene oxide, or copolymers from such monomers. For example, the Jeffamine® polyetheramines family (Huntsman Corporation, The Woodlands, Tex.), consist of monoamines (M series), diamines (D, ED, EDIT series), and triamines (T series) based on polyetherbackbone. The polyether backbone is normally based on either propylene oxide (PO), ethylene oxide (EO), or mixed PO/EO.

The poly(alkoxylate)-amine when used without forming an imidized polymer desirably has a number average molecular weight of 500 to 30,000, in another embodiment from about 600 to about 10,000, and in yet another embodiment from about 1,000 to about 5,000 Daltons. This poly(alkoxylate)-amine can have one or more primary, secondary, and/or tertiary amine groups. While not wishing to be bound by theory, it seems that a balance of water solubility is desirable to function as a silica scale inhibitor. A polymer with more than one terminal amine group seems to be able to function while having more or being entirely repeat units from propylene oxide. A polymer with only one terminal amine group seems to work better with a small proportion of ethylene oxide in the copolymer. In one embodiment, it is desirable that the mole ratio of propylene oxide to ethylene oxide repeating units is from 100:0 to 1:10, in another embodiment the ratio can vary from 10:1 to 1:10, in a third embodiment the ratio can vary from 4:1 to 1:4.

The poly(alkoxylate)-amine when used to form the imidized polymer desirable has a weight average molecular weight from about 200 to 20,000, in another embodiment from 500 to 10,000 and in yet another embodiment from 700 to 5,000 Daltons. This poly(alkoxylate)-amine can have one or more primary, secondary, and/or tertiary amine groups. While not wishing to be bound by theory, it seems desirable to use more mono-amine terminated poly(alkoxylates) in the imidized polymer formation as opposed to “di-” or “tri-” primary amine terminations as the mono primary amine termination would only be bound to the acrylic acid polymer at one terminus rather than having the option to be bound to the acrylic acid polymer or copolymer at more than one location where it could possibly cause crosslinking between two acrylic acid polymers. Alternatively, using secondary amine termination and/or tertiary amine termination on additional terminal groups of the poly(alkoxylate) beyond the first primary amine terminal group does not present as many concerns about too many linkages between the reactants. In this embodiment, it seems desirable to have the mole ratio of propylene oxide to ethylene oxide repeating units vary from 0:1 to 1:10 and in another embodiment from 4:1 to 1:4.

For the purposes of this disclosure, the term “amine terminal group” means a terminal group on the polymer (as opposed to a pendant functionality of low molecular weight attached to the backbone which having very little mobility would separate from the polymer). The preferred structures for the poly(alkoxylate) have terminal amine functionality as this facilitates the functionality being able to get positioned close enough to carboxyl groups on the acrylic polymer for the imidization reaction to occur. However, terminal does not mean that the nitrogen atom has to be the very last atom on a poly(alkoxylate). By means of guidance, it is anticipated that if the nitrogen atom is a member of a terminal group that has 2 to 10 carbon atoms (optionally with OH and or carbonyl functionality in the end group) then it will be sterically free enough to react with the carboxyl groups to form imide or amide linkages. In one embodiment, it is desirable that the nitrogen atom be within 8 atoms of a terminus of the polymer, in another embodiment within 3 or 5 atoms of the terminus and in one embodiment being the last atom or the end of a poly(alkoxylate). These type of end groups are well known to the art and commercial poly(alkoxylate)s are available with such amine terminal groups. In one embodiment, it is desirable that at least one terminal primary amine group be on each poly(alkoxylate), and in one embodiment it is desirable that about 1, e.g., on average about 0.8 to 1.2 primary amine group be present per poly(alkoxylate) with the remaining end group(s) of the poly(alkoxylate) being less reactive with carboxylic acid than the primary amine group.

Jeffamine M series polyetheramines have the following representative structure:

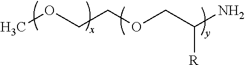

R = H for (EO), or CH₃ for (PO)

| | | Approx. |
|---|---|---|
| | PO/EO | Molecular |
| Jeffamine | Mole Ratio | Weight |
| M-600 (XTJ-505) | 9/1 | 600 |
| M-1000 (XTJ-506) | 3/19 | 1,000 |
| M-2005 (XTJ-507) | 29/6 | 2,000 |
| M-2070 | 10/32 | 2,000 |

Jeffamine D series includes a polymer D-2000 that is a propylene oxide polymer with two terminal primary amine end groups and a molecular weight of about 2,000. Thus, it is similar to the M-2005 and M-2070 polymers but has two terminal amine groups instead of one and has no ethylene oxide repeating units.

Jeffamine SD series includes a polymer SD-2001 that is a propylene oxide polymer with two terminal secondary amine end groups and a molecular weight of about 2000. Thus, it is similar to the D-2000 polymer above but has secondary terminal amine groups instead primary terminal amine groups.

Jeffamine T series includes a polymer T-3000 that is a propylene oxide polymer with three terminal primary amine end groups, a molecular weight of about 3,000 (about 50 PO units), and is made by adding PO units to a triol and terminating all the ends with a primary amine group. Thus, it is similar to a D-2000 polymer but with 1,000 Dalton higher molecular weight and three instead of two terminal primary amine groups.

The structural details on poly(alkoxylate)diamines and poly(alkoxylate)triamines can be obtained from Huntsman Corporation, The Woodland, Tex., www.huntsman.com. Similar poly(alkoxylate)amines are available from BASF Corporation and Air Products.

Imidized acrylic and/or maleic polymers from poly(alkoxylate)-amine reacted with a polymer having pendant carboxylic acid groups (e.g., acrylic acid polymer or copolymer and/or maleic copolymer (copolymer of maleic anhydride or maleic acid)) of the present invention have been unexpectedly found to inhibit silica polymerization and metal silicate deposition under a variety of conditions and in the presence of other water contaminants on equipment surfaces in aqueous systems. The polymer which is imidized is an acrylic polymer and/or maleic copolymer (including terpolymers). The term “acrylic polymer”, as used herein and in the appended claims is a homo-polymer or co-polymer of from about 50 wt. % to about 100 wt. % monethylenically unsaturated carboxylic acids of 3 to 5 carbon atoms (such as acrylic acid, methacrylic acid, their alkali metal salts) in another embodiment from about 75 to 100 wt. %, and in still other embodiments from about 85 or 95 to about 100 wt. %.

The monomers of the acrylic and/or maleate polymers are polymerized by any conventional means known in the art, including emulsion, inverse emulsion, suspension, precipitation, and solution polymerization. This specifically includes living free radical polymerizations such as Atom Transfer Radical Polymerizations (ATRP), Living Free-Radical Processes (Inferter), and by Reversible Addition Fragmentation Chain Transfer (RAFT). Preferably, the polymerization is a free radical solution polymerization. The reaction can take place in a batch, semi-batch or continuous process. Preferably, the polymerization is performed at a low temperature of from about 65 to about 85° C. Generally, the dicarboxylic acid (if present) is fully charged to reactor first, and partially neutralized to improve reactivity. The other monomers and initiator are fed in a delayed manner. The polymerization generally takes up to 5 hours. The solvent polymerization can advantageously be preformed using only water as the solvent, or in a mixed solvent system such as isopropanol/water.

Initiators useful in the polymerization are water-soluble and/or organic-soluble initiators capable of liberating free radicals under the reaction conditions employed. Suitable initiators include peroxides such as benzoyl peroxide, azo compounds such as azobisisobutyronitrile, and salts of peracids (e.g., sodium or potassium persulfate). Redox systems employing, for example, t-butyl hydroperoxide may also be employed. Preferred initiators are persulfates, peroxides, or mixtures thereof. Transition metals are used with the peroxides to create a redox system. The acrylic and/or maleic polymer of the invention is generally a random polymer, though the temperature of polymerization determines how blocky the polymer will be. The polymer may also be a star polymer, or other known architectures. The percent solids are typically in the range of 35 to 55 wt. %. The multifunctional polymer can be post-polymerization neutralized to a desired pH.

The polyalkoxylate with at least one terminal primary, secondary, or tertiary amine or imidized acrylic or maleic polymers may be added neat to the aqueous systems or may be formulated into various water treatment compositions which may then be added to the aqueous systems. Once prepared, the water soluble polymers are preferably incorporated into water treatment compositions comprising other water treatment chemicals including but not limited to dispersants, corrosion inhibitors, and scale inhibitors.

In addition, the acrylic and/or maleic polymer reactant and the resultant imidized acrylic or maleic polymer may contain units derived from other singly or doubly ethylenically unsaturated monomers, such as C₁ to C₃₀ alkyl esters of monoethylenically unsaturated carboxylic acids of 3 to 5 carbon atoms, styrene, alpha-methyl styrene, sulfonated styrene, acrylamidoalkane sulfonic acids where the alkane has up to 6 carbon atoms or in one embodiment from 1 to 4 carbon atoms such as 2-acrylamido-2-methylpropane sulfonic acid or its salts, maleic acid, acrylonitrile, butadiene and the like. In one embodiment, repeat and/or terminal units containing phosphate groups (such as derived from an alkali hypophosphite compound such as described in U.S. Pat. No. 4,681,686 Example 5 or hypophosphorous acid) are included within the acrylic polymer. In a second embodiment, the acrylic and/or maleic polymer is made according to the teachings of U.S. Pat. No. 7,252,770 and includes repeating units from at least four separate groups (dicarboxylic acids, mono-carboxylic acid, nonionic monomers, and sulfonated or sulfated monomers). In a third embodiment, the acrylic polymer or copolymer can comprise up to 50 wt. % of said other singly or doubly ethylenically unsaturated monomer, in another embodiment these may be present from about 1 to 30 wt. %, and in still other embodiments from 1 to 10 or 20 wt. %. In a fourth embodiment, the acrylamidoalkane sulfonic acid or its salt is present in the specified amounts. In a fifth embodiment, a blend of sulfonated styrene and acrylamidoalkane sulfonic acid or their salts are present in the specified amounts. In another embodiment the acrylic and/or maleic polymer can include repeat units derived from unsaturated phosphoric compounds as described in U.S. Pat. No. 7,420,081, such as isopropenylphosphonic acid or its salts. In another embodiment the water treatment can comprise a blend of any of the polymers/copolymers of this specification along with a homo or copolymer of the unsaturated phosphonic compounds of U.S. Pat. No. 7,420,081.

The maleic copolymer may be generally any copolymer of maleic anhydride or its acid form, maleic acid. Maleic anhydride is difficult to homopolymerize to moderate molecular weight using free radical solution polymerization. The comonomers may be a variety of ethylenically unsaturated monomers (as specified above and below) with styrene and C₂ to C₂₀ olefins being popular for their ability to form alternating copolymers. Hydrolysis of anhydride to the diacid promotes water solubility. The copolymer desirable comprises at least 20, 30, or 40 weight percent repeating units from polymerizing maleic acid or its anhydride.

Other ethylenically unsaturated monomer derived units can be present in the subject polymer in an amount of up to about 20 (preferably up to about 10) weight percent of the total polymer provided that the resultant imidized acrylic polymer is water soluble. These other ethylenically unsaturated monomers can include monomers with tertiary amine groups such as suitable monoethylenically unsaturated acid-free monomers include C₁ to C₄ alkyl esters of acrylic or methacrylic acids such as methyl acrylate, ethyl acrylate, butyl acrylate, methyl methacrylate, ethyl methacrylate, butyl methacrylate and isobutyl methacrylate; hydroxyalkyl esters of acrylic or methacrylic acids such as hydroxyethyl acrylate, hydroxypropyl acrylate, hydroxyethyl methacrylate, and hydroxypropyl, methacrylate; acrylamides and alkyl substituted acrylamides including acrylamide, methacrylamide, N-tertiarybutylacrylamide, N-methylacrylamide, and N,N-dimethylacrylamide; dimethylaminoethyl acrylate; dimethylaminoethyl methacrylate; acrylonitrile; methacrylonitrile; allyl alcohol; methallyl alcohol; phosphoethyl methacrylate; 2-vinylpyridene; 4-vinylpyridene; N-vinylpyrrolidone; N-vinylformamide; N-vinylimidazole; vinyl acetate; and styrene. Preferred examples of monoethylenically unsaturated monomers include butyl acrylate, methyl methacrylate, butyl methacrylate, hydroxyethyl acrylate, hydroxyethyl methacrylate, acrylamide, methacrylamide, N-tertiarybutylacrylamide and styrene.

In one embodiment, the acrylic polymer and/or maleic copolymer is soluble to an extent of at least 0.01 wt. % in water at 25° C. (100 ppm), in another, it is soluble to an extent of at least 0.05 wt. % (500 ppm), in still other embodiments, it is soluble to an extent of at least 0.1 wt. % or 1 wt. % (1,000 or 10,000 ppm).

The acrylic polymers and/or maleic copolymers found useful herein are low molecular weight polymers which are soluble in polar solvents such as water. The acrylic polymer and/or maleic copolymer generally has a weight average molecular weight from about 1,000 to about 100,000, in another embodiment from about 2,000 to about 50,000, and in yet another embodiment from about 2,000 to 50,000 Daltons. They should be selected so that the resultant imidized acrylic or maleic polymer has a weight average molecular weight of from about 1 MOO to 100,000 preferably from about 1,500 to 50,000 as determine by GPC using polyacrylic acid standards. Acrylic and/or maleic polymers (both homo-polymers and co-polymers) are formed by conventional free radical polymerization and are commercially available.

The imidized acrylic and/or maleic polymer found useful in the present invention may be formed by reacting an acrylic and/or maleic polymer with ammonia and/or a poly(alkoxylate)-amine (such as the above described alkoxylated amines from Huntsman). When a poly(alkoxylate)-amine is used as a reactant, the imidization may be carried out neat, as the acrylic and/or maleic polymers are soluble in the amines. It is preferred in one embodiment to commence the imidization in small amounts of water. The details of polymerization process, reactants, characterization, purification, etc., may be found in U.S. Pat. No. 5,583,183. In one embodiment, the imidized acrylic and/or maleic polymer of the present invention has a structural units of the formulas:

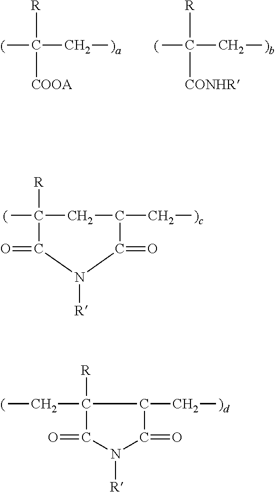

wherein each R independently represents hydrogen atom or a methyl (CH₃—) group; “A” represents a hydrogen atom, a C₁ to C₁₀ linear, branched, or cyclic alkyl group, R′, or an alkali or alkaline earth metal cation or mixture thereof; R′ represents a hydrogen atom or a C₂ to C₁₀, (preferably C₂ to C₄) oxyalkylene group (BO) or a plurality (1 to 200, preferably from 1 to 70) of said groups which is terminated with a C₁ to C₁₀ alkyl group (R″) or a mixture thereof; and “a”, “b”, “c”, and “d” represent molar percentages of the polymer's structure such that a has a value of about 50 to 70; the sum of “b” plus “d” is at least 2 to a value of (100−“a”) and is preferably from 3 to 10; and “b” is not more than [100−(a+c+d)]. The preferred imidized polymer is represented by the above formula in which “A” is a hydrogen atom or an alkali metal cation; R′ is at least 50 to 90 wt. % of the polymer and comprises polyoxyethylene or polyoxypropylene units or mixtures thereof. Further, it is preferred that “a” is a numerical value of from 60 to 70 and the sum of “c” and “d” is a numerical value of at least 3 (preferably at least 5) to the value of (100−“a”). In one embodiment, the weight ratio of acrylic and/or maleic polymer to poly(alkoxylate) is from about 95:5 to 5:95. In a second embodiment, the ratio is from 90:10 to 10:90. In a third embodiment, the ratio is from 80:20 to 10:90. In a third embodiment, the poly(alkoxylate)-amine is reacted in an acid-amine reaction with a phosphonic material (rather than an acrylic or maleic polymer) to form a reaction product for water treatment. Phosphonic materials already known to inhibit scale would be preferred and include phosphonic materials such as AMP (aminotris(methylene phosphoric acid)). HEDP (1-hydroxyethylidine 1,1-diphosphonic acid), DMP (diethylenetriaminepenta(methylenephosphonic acid)), HPA (hydroxyphosphono acetic acid), and PAPEMP (polyamino polyether methylene phosphoric acid).

The present invention will now be further described with reference to a number of specific examples which are to be regarded as illustrative, and is not as restricting the scope of the present invention.

Preparation of Imidized Polymer Example A. This material was made by a process similar to Example 1 of U.S. Pat. No. 5,633,298 comprising taking a solid polyacrylic acid (optionally dissolving in water or dissolving in the polyethylene-propylene oxide) having about 6,000 molecular weight and reacting it with a polyethylene-propylene oxide) polymer of molecular weight 2,000, which was terminated at one end by a primary amine group and at the other end by a methyl group. The weight ratio of solids from the polyacrylic acid to weight of the poly(ethylene-propylene oxide) is (80:20). The polyacrylic acid in this example was basically 100% repeat units from acrylic acid. The two components were reacted under elevated temperature for sufficient time to form a coupled reaction product. The existence of a coupled product can be analyzed by infrared spectroscopy and the resultant spectra had peaks at 1,720 cm⁻¹, 1,630 cm⁻¹, and 750 cm⁻¹ which indicates the presence of imide groups.

Preparation of Imidized Polymer Example B. This material was made by a process similar to Example 1 of U.S. Pat. No. 5,633,298 comprising taking a solid polyacrylic acid (optionally dissolving in water or dissolving in the poly(ethylene-propylene oxide) having about 6,000 molecular weight and reacting it with a poly(ethylene-propylene oxide) polymer of molecular weight 2,000 which was terminated at one end by a primary amine group and at the other end by a methyl group. The weight ratio of solids from the polyacrylic acid to weight of the polyethylene-propylene oxide) is (87:13). The polyacrylic acid in this example was basically 100% repeat units from acrylic acid. The two components were reacted under elevated temperature for sufficient time to form a coupled reaction product. The existence of a coupled product can be analyzed by infrared spectroscopy and the resultant spectra had peaks at 1,720 cm⁻¹, 1630 cm⁻¹ and 750 cm⁻¹ which indicates the presence of imide groups.

Preparation of Imidized Polymer (P-EO-A=P-AA) Examples C, D, and E for Tables 4 and 5. These materials were made by a process similar to Example 1 of U.S. Pat. No. 5,633,298 comprising taking a solid polyacrylic acid (optionally dissolving in water or dissolving in the poly(ethylene-propylene oxide) having about 6,000 molecular weight and reacting it with a poly(ethylene-propylene oxide) polymer of molecular weight 2,000 which was terminated at one end by a primary amine group and at the other end by a methyl group. The weight ratio of solids from the polyacrylic acid to weight of the poly(ethylene-propylene oxide) varied as is specified in Table 4. The polyacrylic acid in this example was basically 100% repeat units from acrylic acid. The two components were reacted under elevated temperature for sufficient time to form a coupled reaction product. The existence of a coupled product can be analyzed by infrared spectroscopy and the resultant spectra had peaks at 1,720 cm⁻¹, 1,630 cm⁻¹, and 750 cm⁻¹ which indicates the presence of imide groups.

Preparation of Imidized Polymer (P-EO-A=P-AA:SA:SS) Examples F, G, and H in Tables 1, 4, and 5. These materials were made by a process similar to Example 1 of U.S. Pat. No. 5,633,298 comprising taking a solid acrylic copolymer of acrylic acid, 2-acrylamido-2-methylpropane sulfonic acid, and styrene sulfonic acid) (sourced as a polymer dissolved in water) having a molecular weight in the range of 5,000 to 15,000 and reacting it with a polyethylene-propylene oxide) polymer of molecular weight 2,000 which was terminated at one end by a primary amine group and at the other end by a methyl group. The weight ratio of solids from the acrylic copolymer to weight of the poly(ethylene-propylene oxide) varied as is specified in Table 4. The two components were reacted under elevated temperature for sufficient time to form a coupled reaction product.

The inhibitors were evaluated for their ability to stabilize remarkably high levels of soluble silica in water. The test measures the ability of an additive to inhibit the polymerization of silica in a solution containing soluble silica (sodium silicate), calcium ion (Ca²⁺), magnesium ion (Mg²⁺), and chloride ion (Cl⁻) at pH 7 and at 40° C. To perform this test, three aqueous solutions were prepared comprising 0.20M Na₂SiO₃, a combination of 0.20M CaCl₂ and 0.20M MgCl₂, and 1,000 ppm of additive, in accordance with the present invention. A 200 mL test solution was prepared which contain 0 to 70 mL of the additive solution, and 5 mL of calcium chloride/magnesium chloride solution, with the volume adjusted to 200 mL with distilled water and pH adjusted to 7.0. The resulting test solution contains 550 ppm soluble silica as SiO₂, 200 ppm Ca, 120 ppm Mg, and 0 to 350 ppm of additive. The test solution is placed in a 220 mL wide mouth polyethylene jar containing a 2-hole rubber stopper. One opening is used for a pH electrode and the second for the sampling. The test solution was stirred with a magnetic stir bar while heated at 40° C. in a circulating water bath maintained at pH 7.0±0.1. A 3 to 5 mL sample was periodically removed and passed through a 0.22 μm filter. A 2.0 mL sample of the filtrate was diluted to 25 mL with distilled water. The concentration of silica in the sample was analyzed according to Hach's high range silica method (Hach Co., Loveland, Colo.). The absorbance of the sample was measured at 450 nm. The reduction in soluble silica is based on the decrease in absorbance relative to the absorbance obtained for the test solution immediately following the preparation. The decline in soluble silica is measured with time, specifically at 0, 5, and 22 hr.

The invention can be best understood by reference to the following examples in which the invention is presented in greater detail. However, the examples are not to be construed to limit the invention herein in any manner, the scope of which is defined in the appended claims.

TABLE 1
Silica Inhibiting Additive Performance Data

| | | | | Silica |
|---|---|---|---|---|
| | | | Additive | Conc. |
| Expt. | | Additive | Conc. | (ppm) |
| No. | Additive | PO/EO Mole Ratio | (ppm) | @ 22 hr |
| 1 | None | N/A | 0.0 | 200 |
| 2 | Boric Acid | N/A | 100 | 226 |
| 3 | Ethanolamine | N/A | 100 | 217 |
| 4 | Triethanolamine | N/A | 100 | 219 |
| 5 | Carbosperse ™ K-732 | N/A | 100 | 230 |
| 6 | Carbosperse K-798 | N/A | 100 | 233 |
| 7 | Acumer ™ 5000 | N/A | 350 | 230 |
| 8 | Versaflex ® Si | N/A | 350 | 235 |
| 9 | P-EOX | N/A | 25 | 515 |
| 10 | PVP K-90 | N/A | 25 | 383 |
| 11 | Pluronic ™ F127NF | 30/70 | 25 | 326 |
| 12 | Pluronic 68NF | 20/80 | 25 | 512 |
| 13 | Pluronic F108 | 20/80 | 25 | 524 |
| 14 | Jeffamine ™ M-2070 | 10/31 | 12.5 | 487 |
| 15 | Jeffamine M-2070 | 10/31 | 25 | 510 |
| 16 | Jeffamine M-2070 | 10/31 | 50 | 540 |
| 17 | Jeffamine M-1000 | 3/19 | 12.5 | 275 |
| 18 | Jeffamine M-2005 | 29/6 | 12.5 | 303 |
| 19 | Jeffamine M-2005 | 29/6 | 25 | 515 |
| 20 | Jeffamine D-2000 | 33/0 | 12.5 | 507 |
| 21 | Jeffamine T-3000 | 50/0 | 12.5 | 510 |
| 22 | Jeffamine SD-2001 | 33/0 | 12.5 | 476 |
| 23 | Example A | 10/31 + Polyacrylic | 6.5 | 278 |
| | | (80:20) | | |
| 24 | Example A | 10/31 + Polyacrylic | 12.5 | 495 |
| | | (80:20) | | |
| 25 | Example A | 10/31 + Polyacrylic | 25 | 485 |
| | | (80:20) | | |
| 26 | Example A | 10/31 + Polyacrylic | 50 | 495 |
| | | (80:20) | | |
| 27 | Example B | 10/31 + Polyacrylic | 6.5 | 263 |
| | | (87:13) | | |
| 28 | Example B | 10/31 + Polyacrylic | 12.5 | 505 |
| | | (87:13) | | |
| 29 | Example B | 10/31 + Polyacrylic | 25 | 490 |
| | | (87:13) | | |
| 30 | Example B | 10/31 + Polyacrylic | 50 | 498 |
| | | (87:13) | | |
| 31 | Example F | 10/31 + AA:SA:SS | 25 | 518 |
| | | (80:20) | | |
| 32 | Example G | 10/31 + AA:SA:SS | 25 | 521 |
| | | (65:35) | | |
| 33 | Example H | 10/31 + AA:SA:SS | 25 | 487 |
| | | (50:50) | | |

Key:
Versaflex Si: acrylic acid-based copolymer supplied by Alco Chemical Co.;
Carbosperse K-798 = copolymer of acrylic acid: 2-acrylamido-2-methylpropane sulfonic acid: sulfonated styrene (supplied by Lubrizol Advanced Materials, Inc.);
Carbosperse K-732 = poly(acrylic acid); Acumer 5000 = terpolymer of acrylic acid, 2-acrylamido-2-methylpropane sulfonic acid, non-ionic monomer (supplied by Rohm and Haas);
Pluronic ™ F127 = 12,600 MW (one of a family of block copolymers based on ethylene oxide and propylene oxide supplied by BASF);
Pluronic F68 = 8,400 MW; Pluronic F108 = 14,600 MW. The various Jeffamine polymers of various designations are defined earlier in the specification.
The imidized polymer Example A is one of the examples and its preparation is described in this section of this disclosure.
P-AA:SA:SS is a copolymer of acrylic acid, 2-acrylamido-2-methylpropane sulfonic acid, and styrene sulfonic acid;
SA is a repeat unit derived from 2-acrylamide-2-methylpropane sulfonic acid, and
SS is a repeat unit derived from styrene sulfonic acid.
The numbers in parentheses represents the weight ratio of poly(ethylene-propylene oxide) to acrylic polymer in the imidized polymer.

The performance data for additives of the present invention and commercial additives are summarized in Table 1. It is evident that all non-polymeric additives (e.g., boric acid, ethanolamine, triethanolamine) are ineffective silica inhibitors in this particular test. The data in Table 1 also reveal that acrylic acid containing polymers (i.e., K-732, K-798, Versaflex Si, Acumer 5000) exhibit poor performance. As illustrated in Table 1, additives of the present invention, i.e., alkoxylated mono, di-, triamines, and imidized polymer (i.e., reaction product of polyalkoxylate with one primary amine terminal group and one terminal methyl group with an acrylic polymer in a weight ratio of 6,000) show excellent performance in inhibiting silica scale formation.

Further, the additives of the present invention could be combined with a variety of other water treatment chemicals or compositions, including surfactants, phosphonates and their salts, phosphoric acid, metal chelating agents, oxygen scavengers, and other scale inhibiting agents. Thus, the additives of the present invention are useful in a wide variety of aqueous, including, but not limited to, cooling water systems, boiler water systems, desalination systems, reverse osmosis systems, evaporator systems, gas scrubber water systems, blast furnace water systems, paper manufacturing systems, geothermal applications and the like.

Table 2 presents performance data on Jeffamine M-2070 (JAA M-2070) or imidized polymer (Imidized polymer Example A) in combination with poly(acrylic acid), Carbosperse K-752 and ter-polymer (K-798). It is evident from the data in Table 1 and Table 2 that neither homo- nor ter-polymers by themselves function as silica inhibitors.

TABLE 2
Performance Data for Silica Inhibiting Additives in
Combination with a Polyacrylic Acid or Acrylic Acid Terpolymer

| | | Additive | | Polymer | Silica |
|---|---|---|---|---|---|
| Expt. | | Conc. | | Conc. | (ppm) |
| No. | Additive | (ppm) | Polymer | (ppm) | @ 22 hr |
| 34 | None | N/A | None | 0.0 | 200 |
| 35 | Jeffamine ™ M-2070 | 25.0 | None | 0.0 | 510 |
| 36 | JAA M-2070 | 12.5 | K-798 | 12.5 | 487 |
| 37 | JAA M-2070 | 0.0 | K-798 | 12.5 | 217 |
| 38 | JAA M-2070 | 0.0 | K-798 | 25.0 | 220 |
| 39 | JAA M-2070 | 12.5 | K-752 | 12.5 | 504 |
| 40 | JAA M-2070 | 0.0 | K-752 | 12.5 | 214 |
| 41 | JAA M-2070 | 0.0 | K-752 | 25.0 | 219 |
| 42 | Example A | 25.0 | None | 0.0 | 490 |
| 43 | Example A | 12.5 | K-798 | 12.5 | 498 |
| 44 | Example B | 12.5 | K-798 | 12.5 | 495 |
| 45 | Example B | 12.5 | K-775 | 12.5 | 487 |
| 46 | Example F | 12.5 | K-798 | 12.5 | 490 |

Key:
The Jeffamines, Imidized polymer Example A, Example B, Example F, and Carbosperse K-752 and K-798 were defined after Table 1.

Table 3 presents silica inhibition data on silica inhibitors and phosphonates collected in the presence of ferric ions (Fe³⁺). This test is similar to that of Tables 1 and 2 except Fe³⁺ is, added. As shown in Table 3, the presence of low level of Fe³⁺ exhibits antagonistic effect on the performance of silica inhibitor (i.e., the level of soluble silica goes down as the Fe³⁺ concentration increases in the absence of a phosphonate). The data in Table 3 also show that the silica inhibitor performance can be maintained by the addition of low levels of phosphonates. Although data presented in Table 3 are on HEDP and DMP, other commercial phosphonates can also be used. In addition, results presented in Table 3 show that imidized polymers and blends of imidized polymers with K-700 exhibit good tolerance to low levels of (Fe³⁺).

TABLE 3
Effect of Fe³⁺ on Silica Inhibitor Performance
in the Presence and Absence of Phosphonates

| | | | Fe³⁺ | | Phos.* | Silica |
|---|---|---|---|---|---|---|
| Expt. | | Additive | Conc. | Phos.* | Conc. | (ppm) |
| No. | Additive | Conc. (ppm) | (ppm) | Type** | (ppm) | @ 22 hr |
| 47 | None | N/A | 0.0 | None | 0.0 | 200 |
| 48 | JAA M-2070 | 25.0 | 0.0 | None | 0.0 | 510 |
| 49 | JAA M-2070 | 25.0 | 1.0 | None | 0.0 | 423 |
| 50 | JAA M-2070 | 25.0 | 1.5 | None | 0.0 | 389 |
| 51 | JAA M-2070 | 25.0 | 1.0 | HEDP | 15.0 | 504 |
| 52 | JAA M-2070 | 0.0 | 0.0 | HEDP | 15.0 | 209 |
| 53 | JAA M-2070 | 0.0 | 0.0 | None | 0.0 | 228 |
| 54 | JAA M-2070 | 25.0 | 1.0 | DMP | 15.0 | 501 |
| 55 | JAA M-2070 | 0.0 | 0.0 | DMP | 15.0 | 214 |
| 56 | Example A | 25.0 | 1.0 | HEDP | 15.0 | 470 |
| 57 | Example B | 25.0 | 0.0 | None | 0.0 | 490 |
| 58 | Example B | 25.0 | 1.0 | None | 0.0 | 421 |
| 59 | Example B | 25.0 | 0.0 | None | 0.0 | 485 |
| 60 | Example B + | 12.5 + 12.5 | 0.5 | None | 0.0 | 401 |
| | K-798 | | | | | |
| 61 | Example B + | 12.5 + 12.5 | 1.0 | None | 0.0 | 290 |
| | K-798 | | | | | |

Key: The Jeffamines, Imidized polymers Example A, Example B, and Carbosperse K-752 and K-798 were defined after Table 1.
*Phos. = Phosphonate.
**Phosphonate Type: HEDP: 1-hydroxyethylidine 1,1-diphosphonic acid, DMP = diethylenetriaminepenta(methylenephosphonic acid).

Iron Oxide Dispersion: The performance of Carbosperse K-732 and K-798, and Huntsman's Jeffamine M-2070, and imidized polymer Example A and either K-732 or K-798 were studied for iron oxide dispersion using a standard test method (Z. Amjad & R. Zuhl, “The Role of Polymers in Water Treatment Applications and Criteria for Comparing Alternatives,” Association Water Technologies, 1993 Annual Convention). The results summarized in Table 4 below clearly show that imidized polymers performed better than either Jeffamine M-2070 (JAA M-2070) or the Carbosperse K-700 polymers. In addition, blends of imidized polymers and K-700 polymers also exhibit excellent iron oxide dispersion.

TABLE 4
Iron Oxide Dispersion by Carbosperse
K-700 Polymers and Ethoxylated Mono Amine

| Expt. | | | Dosage | Dispersion |
|---|---|---|---|---|
| No. | Polymer | Composition | (ppm) | (%)* |
| 62 | K-732 | P-AA (100) | 0 | 0 |
| 63 | K-732 | P-AA (100) | 0.25 | 24 |
| 64 | K-732 | P-AA (100) | 0.50 | 33 |
| 65 | K-732 | P-AA (100) | 1.0 | 38 |
| 66 | JAA M-2070 | P-EO-A (100) | 1.0 | 1 |
| 67 | Example B | P-EO-A═P-AA (87:13) | 0.5 | 79 |
| 68 | Example B | P-EO-A═P-AA (87:13) | 1.0 | 90 |
| 69 | Example B | P-EO-A═P-AA (87:13) | 2.0 | 96 |
| 70 | Example A | P-EO-A═P-AA (80:20) | 0.5 | 80 |
| 71 | Example A | P-EO-A═P-AA (80:20) | 1.0 | 92 |
| 72 | Example C | P-EO-A═P-AA (65:35) | 0.5 | 87 |
| 73 | Example E | P-EO-A═P-AA (50:50) | 0.5 | 81 |
| 74 | K-798 | P-AA:SA:SS | 0.25 | 48 |
| 75 | K-798 | P-AA:SA:SS | 0.50 | 62 |
| 76 | K-798 | P-AA:SA:SS | 1.0 | 83 |
| 77 | K-798 | P-AA:SA:SS | 2.0 | 88 |
| 78 | Example A + | P-EO-A═P-AA (80:20) + P- | 1.0 | 72 |
| | K-798 | AA:SA:SS | | |
| 79 | Example A + | P-EO-A═P-AA (80:20) + P- | 2.0 | 92 |
| | K-798 | AA:SA:SS | | |
| 80 | K-775 | P-AA:SA | 1.0 | 64 |
| 81 | Example A + | P-EO-A═P-AA (80:20) + P- | 1.0 | 68 |
| | K-775 | AA:SA | | |
| 82 | Example A + | P-EO-A═P-AA (80:20) + P- | 2.0 | 82 |
| | K-775 | AA:SA | | |
| 83 | Example F | P-EO-A═P-AA:SA:SS | 0.5 | 53 |
| | | (80:20) | | |
| 84 | Example G | P-EO-A═P-AA:SA:SS | 0.5 | 69 |
| | | (65:35) | | |
| 85 | Example H | P-EO-A═P-AA:SA:SS | 0.5 | 73 |
| | | (50:50) | | |

*A higher % dispersion reading indicates better performance.
Key:
P-AA is poly(acrylic acid),
P-EO-A is a poly(ethylene-propylene oxide) with one amine terminal group;
P-AA:SA:SS is a copolymer of acrylic acid, 2-acrylamido-2-methylpropane sulfonic acid, and styrene sulfonic acid;
SA is a repeat unit derived from 2-acrylamido-2-methylpropane sulfonic acid, and
SS is a repeat unit derived from styrene sulfonic acid;
P-AA:SA is a copolymer of acrylic acid and 2-acrylamide-2-methylpropane sulfonic acid.
The ‘═’ designates a chemical bond between the P-EO-A and the acrylic acid polymer or copolymer to form the imidized copolymer.
The value in parentheses for the imidized polymers is the weight ratio of the P-EO-A to the acrylic acid polymer or copolymer.

Iron Stabilization: The performance of Huntsman's Jeffamine M-2070, poly(acrylic acid) or P-AA, P-AA:SA:SS, and imidized acrylic polymers from M-2070: K-732 or K-798 was studied for iron stabilization using a standard test method is shown in Table 5. The results summarized in Table 5 clearly show that the M-2070 is an ineffective iron stabilization agent (see Expt. Nos. 87 to 89) whereas the imidized acrylic polymers (see Expt. Nos. 90 to 100) show good iron stabilization properties.

TABLE 5
Iron Stabilization for Polyether Mono Amine,
Comb or Imidized Polymers, and Carbosperse K-700 Polymers

| Expt. | | | Dosage | % Fe |
|---|---|---|---|---|
| No. | Polymer* | Composition** | (ppm) | Stabilization*** |
| 86 | None | N/A | 0 | 0 |
| 87 | JAA M-2070 | EO-A (100) | 20 | 0.4 |
| 88 | JAA M-2070 | EO-A (100) | 35 | 0.5 |
| 89 | JAA M-2070 | EO-A (100) | 50 | 0.5 |
| 90 | Example B | P-EO-A:AA (87:13) | 20 | 12 |
| 91 | Example B | P-EO-A:AA (87:13) | 35 | 35 |
| 92 | Example B | P-EO-A:AA (87:13) | 50 | 52 |
| 93 | Example A | P-EO-A:AA (80:20) | 35 | 37 |
| 94 | Example A | P-EO-A:AA (80:20) | 50 | 57 |
| 95 | Example C | P-EO-A:AA (65:35) | 35 | 41 |
| 96 | Example D | P-EO-A:AA (60:40) | 35 | 46 |
| 97 | Example E | P-EO-A:AA (50:50) | 35 | 37 |
| 98 | Example F | P-EO-A:AA:SA:SS | 35 | 36 |
| | | (80:20) | | |
| 99 | Example G | P-EO-A:AA:SA:SS | 35 | 50 |
| | | (65:35) | | |
| 100 | Example H | P-EO-A:AA:SA:SS | 35 | 63 |
| | | (50:50) | | |
| 101 | Example H | P-EO-A:AA:SA:SS | 35 | 68 |
| | | (50:50) | | |
| 102 | K-732 | P-AA | 10 | 15 |
| 103 | K-732 | P-AA | 20 | 64 |
| 104 | K-798 | P-AA:SA:SS | 20 | 95 |

*Polymers A through H are imidized acrylic polymers from M-2070: K-732 or K-798.
**Key to the monomers incorporated in the acrylic polymers or comb polymers above include AA = acrylic acid, SA = 2-acrylamido-2-methylpropane sulfonic acid. SS = sulfonated styrene.
***higher % stabilization reading indicates better performance

Clay Dispersion: The performance of Carbosperse K-700 polymers, polyether mono amine, and comb polymers as clays dispersants was determined by dispersing clay (1 g) in 100 mL of synthetic water containing 0 to 10 ppm of additives. The synthetic water used has the same composition as used in iron oxide dispersion test described above. Results expressed as % dispersed for 10 ppm additive were obtained at 3 hr and are summarized in Table 6. It is evident that polymers (Example A and Example F) of the present invention exhibit unexpected superior performance compared to Jeffamine M-2070 and Carbosperse K-732 or K-798. Dispersancy data presented in Table 6 also show that physical blends of M-2070 with K-732 or K-798 are not as effective dispersants as polymers of the present invention. In addition, blends of Carbosperse K-700 polymers with imidized polymers are also effective clay dispersants.

TABLE 6
Clay Dispersion for Polyether Mono Amine,
Comb or Imidized Polymers, and Carbosperse K-700 Polymers

| Expt. | | | Dosage | % |
|---|---|---|---|---|
| No. | Polymer* | Composition** | (ppm) | Dispersed*** |
| 105 | None | N/A | 0 | 0 |
| 106 | JAA M-2070 | EO-A (100) | 2.5 | 2 |
| 107 | JAA M-2070 | EO-A (100) | 5.0 | 4 |
| 108 | JAA M-2070 | EO-A (100) | 10.0 | 6 |
| 109 | K-732 | P-AA | 2.5 | 16 |
| 110 | K-732 | P-AA | 5.0 | 21 |
| 111 | K-732 | P-AA | 10.0 | 24 |
| 112 | Example A | P-EO-A:AA (80:20) | 2.5 | 13 |
| 113 | Example A | P-EO-A:AA (80:20) | 5.0 | 39 |
| 114 | Example A | P-EO-A:AA (80:20) | 10.0 | 88 |
| 115 | JAA M-2070 + K-732 | EO-A (100) + P-AA | 8 + 2 | 16 |
| 116 | JAA M-2070 + | EO-A (100) + P-AA | 5 + 5 | 26 |
| | K-732 | | | |
| 117 | K-798 | P-AA:SA:SS | 10 | 81 |
| 118 | Example F | P-EO-A:AA:SA:SS (80:20) | 10 | 86 |
| 119 | JAA M-2070 + K-798 | EO-A (100) + P-AA:SA:SS | 2 + 8 | 49 |
| 120 | JAA M-2070 + K-798 | EO-A (100) + P-AA:SA:SS | 5 + 5 | 74 |
| 121 | Example A + K-798 | P-EO-A:AA (80:20) P-AA:SA:SS | 10 | 81 |
| 122 | Example A + K-775 | P-EO-A:AA (80:20) + P-AA:SA | 10 | 75 |
| 123 | K-775 | P-AA:SA | 10 | 71 |

*Polymers A and F are imidized acrylic, polymers from M-2070: K-732 or K-798.
**Key to the monomers incorporated in the acrylic polymers or comb polymers above include AA = acrylic acid, SA = 2-acrylamido-2-methylpropane sulfonic acid, SS = sulfonated styrene.
***higher % dispersed reading indicates better performance.

Silica Dispersion: The silica dispersion by various additives was studied by dispersing 60 mg silica in 100 mL of synthetic water of the composition used in iron oxide dispersion experiments. Results expressed as % dispersed collected at hr in the presence of varying concentrations of additives are presented in Table 7. It is evident from the data, that polymers of the present invention (Example A and Example F) are effective dispersants for silica and show unexpected dispersancy activity compared to physical blends of ethoxylated monoamine and K-700 polymers. In addition, blends of imidized polymers with K-700 polymers show excellent dispersancy activity for clay.

TABLE 7
Silica Dispersion for Polyether Mono Amine,
Comb or Imidized Polymers, and Carbosperse K-700 Polymers

| Expt. | | | Dosage | % |
|---|---|---|---|---|
| No. | Polymer* | Composition** | (ppm) | Dispersed*** |
| 124 | None | N/A | 0 | 0 |
| 125 | JAA M-2070 | EO-A (100) | 0.25 | 0 |
| 126 | JAA M-2070 | EO-A (100) | 0.50 | 0 |
| 127 | JAA M-2070 | EO-A (100) | 1.0 | 3 |
| 128 | K-732 | P-AA | 0.25 | 35 |
| 129 | K-732 | P-AA | 0.50 | 42 |
| 130 | K-732 | P-AA | 1.0 | 50 |
| 131 | Example A | P-EO-A:AA (80:20) | 0.25 | 60 |
| 132 | Example A | P-EO-A:AA (80:20) | 0.50 | 67 |
| 133 | Example A | P-EO-A:AA (80:20) | 1.0 | 70 |
| 134 | JAA | EO-A (100) + P-AA | 0.80 + 0.20 | 40 |
| | M-2070 + | | | |
| | K-732 | | | |
| 135 | K-798 | P-AA:SA:SS | 0.25 | 58 |
| 136 | K-798 | P-AA:SA:SS | 0.5 | 62 |
| 137 | K-798 | P-AA:SA:SS | 1.0 | 66 |
| 138 | Example F | P-EO-A:AA:SA:SS | 1.0 | 69 |
| | | (80:20) | | |
| 139 | JAA | EO-A + P- | 0.80 + 0.20 | 58 |
| | M-2070 + | AA:SA:SS | | |
| | K-798 | | | |
| 140 | Example A + | P-EO- | 1.0 | 67 |
| | K-798 | A:AA (80:20) + | | |
| | | P-AA:SA:SS | | |

*Example A and Example F are imidized acrylic polymers from M-2070: K-732 or K-798.
**Key to the monomers incorporated in the acrylic polymers or comb polymers above include AA = acrylic acid, SA = 2-acrylamido-2-methylpropane sulfonic acid. SS = sulfonated styrene.
***higher % dispersed reading indicates better performance.

Magnesium Silicate Dispersion: The dispersion of magnesium silicate in synthetic water containing varying dosages of additives was determined by dispersing magnesium silicate (150 mg) in 100 mL synthetic water. The composition of synthetic water was the same as used in iron oxide dispersion experiments described above. Results collected at 2 hr and presented in Table 8 show that polymers of the present invention (Example A) provide unexpected superior performance as magnesium silicate dispersants than ethoxylated amine (M-2070) and K-732. In addition, blends of imidized polymers with K-700 polymers also show excellent performance as magnesium silicate dispersants.

TABLE 8
Magnesium Silicate Dispersion for Polyether Mono Amine,
Comb or Imidized Polymers, and Carbosperse K-700 Polymers

| Expt. | | | Dosage | % |
|---|---|---|---|---|
| No. | Polymer* | Composition** | (ppm) | Dispersed*** |
| 141 | None | N/A | 0 | 0 |
| 142 | JAA M-2070 | EO-A (100) | 2.5 | 1 |
| 143 | K-732 | P-AA | 2.5 | 39 |
| 144 | Example A | P-EO-A:AA (80:20) | 2.5 | 60 |
| 145 | JAA | EO-A + P-AA | 2.0 + 0.5 | 19 |
| | M-2070 + | | | |
| | K-732 | | | |
| 146 | K-798 | P-AA:SA:SS | 2.5 | 54 |
| 147 | Example A + | P-EO-A:AA (80:20) + | 2.5 | 57 |
| | K-798 | P-AA:SA:SS | | |
| 148 | Example A + | P-EO-A:AA (80:20) + | 2.5 | 57 |
| | K-775 | P-AA:SA:SS | | |

*Example A is an imidized acrylic polymer from M-2070: K-732.
**Key to the monomers incorporated in the acrylic polymers or comb polymers above include AA = acrylic acid, SA = 2-acrylamido-2-methylpropane sulfonic acid. SS = sulfonated styrene.
***higher % dispersed reading indicates better performance

Magnesium Silicate Dispersion by Additives in the Presence of Stressed Water Chemistry The impact of water chemistry on the performance of K-700 and comb polymers, and ethoxylated monoamine was investigated by dispersing magnesium silicate (150 mg) in 100 mL of synthetic water; (a) water composition (1×) similar to the water composition used in iron oxide dispersion and (b) water chemistry (3×) or the same as used in iron oxide dispersion test but with a three-fold increase in calcium, magnesium, chloride, and sulfate levels. Dispersion data summarized in Table 9 for 2.5 ppm K-732, M-2070, and comb polymer show that polymers of the present invention are more tolerant to stressed water composition than either K-732 or M-2070.

TABLE 9
Magnesium Silicate Dispersion for Polyether Mono Amine,
Comb or Imidized Polymers, and Carbosperse K-700 Polymers.
The Effect of Water Chemistry

| | | | % | |
|---|---|---|---|---|
| | | | Dispersed | % |
| Expt. | | | (1X) from | Dispersed |
| No. | Polymer* | Composition** | Table 8 | (3X)*** |
| 149 | None | N/A | 0 | 0 |
| 150 | JAA M-2070 | EO-A (100) | 1 | 0 |
| 151 | K-732 | P-AA | 39 | 4 |
| 152 | Example A | P-EO-A:A (80:20) | 60 | 56 |
| 153 | K-798 | P-AA:SA:SS | 54 | 42 |
| 154 | K-775 | P-AA:SA | 49 | 38 |
| 155 | Example A + | P-EO-A:A (80:20) + | 57 | 52 |
| | K-798 | P-AA:SA:SS | | |
| 156 | Example A + K-775 | P-EO-A:A (80:20) + | 57 | 49 |
| | | P-AA:SA | | |

*Example A is an imidized acrylic polymer from M-2070: K-732.
**Key to the monomers incorporated in the acrylic polymers or comb polymers above include AA = acrylic acid, SA = 2-acrylamido-2-methylpropane sulfonic acid. SS = sulfonated styrene.
***higher % dispersed reading indicates better performance.

The foregoing embodiments of the present invention have been presented for the purpose of illustration and description. These descriptions and embodiments are not intended to be exhaustive or to limit the invention to the precise form disclosed, and obviously many modifications and variations are possible in the light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

1. A method of inhibiting the deposition of silica and silicate compounds in an aqueous systems comprising adding to said system an effective amount of silica inhibitor comprising a poly(alkoxylate) with at least one terminal primary or secondary amine reacted with an acrylic and/or maleic polymer having pendant carboxylic acid groups to form an amidized and/or imidized acrylic or maleic polymer with a weight ratio of acrylic polymer to poly(alkoxylate) of from about 5:95 to about 95:5.

2. The method of claim 1 wherein the amidized and/or imidized polymer has a weight ratio of the poly(alkoxylate) to the acrylic acid polymer of from about 90:10 to about 10:90.

3. The method of claim 1, wherein said silica inhibitor is comprised of at least said B) a poly(alkoxylate) with at least one terminal primary or secondary amine reacted with an acrylic and/or maleic polymer having pendant carboxylic acid groups to form an amidized and/or imidized acrylic or maleic polymer with a weight ratio of acrylic or maleic polymer to poly(alkoxylate) of from about 5:95 to about 95:5; said poly(alkoxylate) with at least one terminal primary or secondary amine has a number average molecular weight from about 500 to about 20,000, and said acrylic polymer having pendant carboxylic acid groups is a polymer from 50 to 100 wt. % monoethylenically unsaturated monomers having from 3 to 5 carbon atoms, up to 50 wt. % acrylamidoalkanesulfonic acid where the alkane has from 1 to 6 carbon atoms, and other optional ethylenically unsaturated monomers, said acrylic polymer has a weight average molecular weight from about 1,000 to 100,000; and said acrylic polymer is characterized as having before reacting with said poly(alkoxylate) a water solubility of at least 0.01 wt. % in water at 25° C. (100 ppm solubility).

4. The method of claim 3 wherein the amidized and/or imidized polymer has a weight ratio of the poly(alkoxylate) to the acrylic acid polymer of from about 90:10 to about 10:90.

5. The method of claim 1 wherein said silica inhibitor is present in an amount between about 1.0 and 350 ppm based on the weight of said aqueous system.

6. (canceled)

7. The method of claim 1 wherein said silica inhibitor is combined with an effective amount of a homo- or a co-polymer co-stabilizer containing repeat units from acrylic acid and/or maleic acid whereby mineral scale is inhibited in the water system.

8. The method of claim 1 wherein said silica inhibitor is combined with an effective amount of corrosion inhibitor whereby corrosion inhibition is provided in the water system.

9. The method of claim 1 wherein the said silica inhibitor is combined with an effective amount of a phosphonate whereby mineral scale inhibition and corrosion are provided in the water system.

10. The method of claim 1 wherein said silica inhibitor is combined with effective amounts of polymer co-stabilizers, metal chelating agents, oxygen scavengers, suspending aids, and corrosion inhibitors whereby dispersion of suspending matter and mineral scale, stabilization of metal ions, and corrosion inhibition are provided in the water system.

11. A method for controlling particulate matter such as iron oxide, magnesium silicate, clay, silica or silicate scale formation in an aqueous systems comprising adding to the said system an effective amount of scale inhibitor comprising a blend of:
A) a water soluble ter-polymer of (meth)acrylic acid or maleic acid or salts thereof of having a weight average molecular weight of from about 1,000 to about 25,000, where the ter-polymer is formed:
1) from about 30 to about 80 wt. % of (meth)acrylic acid or maleic acid (wherein (meth)acrylic means acrylic and/or methacrylic), and
2) from about 11 to about 40 wt. % of a (meth)acrylamidomethyl propane sulfonic acid or styrene sulfonic acid, and/or from about 3 to about 30 wt. % of styrene sulfonic acid; and
B) an alkoxylated amine having a weight average molecular weight from about 500 to about 20,000; or
C) an amidized or imidized acrylic polymer formed from reacting a poly(alkoxylate) with at least one terminal primary or secondary amine having 3 to 70 alkoxylate repeat units reacted with an acrylic polymer or copolymer of number average molecular weight from about 1,000 to 50,000 having pendant carboxylic acid groups.

12. A method according to claim 11, wherein said scale inhibitor further functions as dispersants for particulate matter such as iron oxide, clay, silica, magnesium silicate.

13. A method according to claim 11, wherein said scale inhibitor further functions as a metal ion stabilization agent.

14. A method according to claim 11, further comprising phosphonic acid or homo or copolymers of acrylamidoalkane sulfonic acid or styrene sulfonate.

15. Imidized polymers composed of an poly(alkoxylate)-amine reacted with one of the following: A) a carboxylic containing polymer selected from maleic homo- and co-polymers, (meth)acrylic copolymers, maleic and (meth)acrylic homo- and co-polymers made using hypophosphinate; B) poly-2-acrylamido methyl propane sulfonic acid; C) poly-sulfonated styrene, D) a carboxylic containing polymer selected from maleic homo- and co-polymers, (meth)acrylic copolymers, maleic and (meth)acrylic homo- and co-polymers made using a living free radical polymerization process; and E) phosphonic acids.

16. A method of inhibiting the deposition of silica and silicate compounds in an aqueous systems comprising adding to said system an effective amount of silica inhibitor comprising a poly(alkoxylate) with at least one terminal primary or secondary amine reacted with a polymer having pendant carboxylic acid groups to form an amidized and/or imidized polymer with a weight ratio of polymer having pendant carboxylic acid groups to poly(alkoxylate) of from about 5:95 to about 95:5; said polymer characterized by structural units of the formulas: 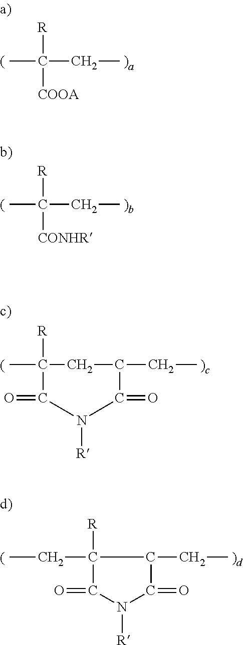
wherein each R independently represents hydrogen atom or a methyl (CH₃—) group; A represents a hydrogen atom, a C₁-C₁₀ linear, branched or cyclic alkyl group, R′, or an alkali or alkaline earth metal cation or mixture thereof; R′ represents a hydrogen atom or a C₂ to C₁₀ (preferably C₂ to C₄) oxyalkylene group (BO) or a plurality of said oxyalkylene groups which is terminated with a C₁ to C₁₀ alkyl group (R″) or a mixture thereof; and “a,” “b,” “c,” and “d” represent molar percentages of the polymer's structure such that “a” has a value of about 50 to 70; the sum of “b” plus “d” is at least 2 to a value of (100−a) and is preferably from 3 to 10; and “b” is not more than [100−(a+c+d)].

17. A method of inhibiting the deposition of silica and silicate compounds in an aqueous systems comprising adding to said system an effective amount of silica inhibitor comprising a blend of:
A) a water soluble ter-polymer of (meth)acrylic acid or maleic acid or salts thereof of having a weight average molecular weight of from about 1,000 to about 25,000, where the ter-polymer is formed:
1) from about 30 to about 80 wt. % of (meth)acrylic acid or maleic acid (wherein (meth)acrylic means acrylic and/or methacrylic), and
2) from about 11 to about 40 wt. % of a (meth)acrylamidomethyl propane sulfonic acid or styrene sulfonic acid, and/or from about 3 to about 30 wt. % of styrene sulfonic acid; and
B) an alkoxylated amine having a weight average molecular weight from about 500 to about 20,000; or
C) an amidized or imidized acrylic polymer formed from reacting a poly(alkoxylate) with at least one terminal primary or secondary amine having 3 to 70 alkoxylate repeat units reacted with an acrylic polymer or copolymer of number average molecular weight from about 1,000 to 50,000 having pendant carboxylic acid groups.
